(19) United States
(12) Patent Application Publication
(10) Pub. No.: US 2019/0113460 A1
(43) Pub. Date: Apr. 18, 2019

(54) NANOSTRUCTURED MATERIALS

(71) Applicants: Flavius Cristian Pascut, Nottingham (GB); Kevin Francis Webb, Nottingham (GB); Gregory Madejski, Rochester, NY (US); James McGrath, Rochester, NY (US)

(72) Inventors: Flavius Cristian Pascut, Nottingham (GB); Kevin Francis Webb, Nottingham (GB); Gregory Madejski, Rochester, NY (US); James McGrath, Rochester, NY (US)

(21) Appl. No.: 15/764,382

(22) PCT Filed: Sep. 30, 2016
(86) PCT No.: PCT/GB2016/053046

§ 371 Date: Mar. 29, 2018

Related U.S. Application Data
(60) Provisional application No. 62/235,929, filed on Oct. 1, 2015.

(51) Int. Cl. G01N 21/65

(52) U.S. Cl. CPC G01N 21/658; G01N 21/554

(57) ABSTRACT

A method of making a SERS active substrate and a SERS active substrate. The method comprises depositing a first layer and replicating a plurality of pores of a nanoporous template layer in the first layer so as to define corresponding pores in the first layer. The first layer consists of a metal. Depositing the first layer comprises at least partially coating the sidewalls of the pores of the nanoporous template layer, thereby defining a plurality of out-of-plane SERS active nanofeatures in the first layer.

The present invention relates to a device comprising nanostructured materials, and to a method of making a nanostructured material. More specifically, the present invention is particularly relevant to surface enhanced Raman scattering active substrates.

Raman spectroscopy is a sensitive analytic method in which a light source (typically a laser) illuminates a sample to produce scattered photons. The scattered photons include elastically scattered photons (in which the wavelength of the scattered light is the same as that of the illuminating light), and inelastically scattered light (in which the wavelength of the scattered light is shifted relative to the illuminated light. One type of inelastic scattering is Raman scattering, in which interactions of photons with atoms or molecules results in a shift in wavelength of the scattered light (referred to as a Stokes shift) that is characteristic of the particular atom or molecule. Raman scattered light can therefore be used to determine a quantitative fingerprint of the molecular species that are within the illumination beam.

Surface enhanced Raman scattering (SERS) is a non-linear process whereby the interaction of light with nanostructured materials (i.e. materials having structure with features at the scale of 1 nm to 200 nm) produces plasmonic concentration of the electromagnetic field, at the nanoscale, around nanostructured materials that are capable of supporting a plasmon. Such materials include gold, silver and platinum. Commercially available SERS substrates (for enhancing Raman by SERS) tend to be relatively expensive, because they are typically produced with processes that do not scale particularly well to volume manufacture. Current technologies for making SERS substrates are restricted to expensive, laborious and non-scalable technologies such as ion beam etching (e.g. focussed ion beam milling), nanolithography, or polymer replication from master structures created using these and similar methods.

More generally, nanostructured material layers find a wide range of applications beyond SERS. New ways of forming nanostructured layers, and new configurations of structured materials, are likely to be applicable in other areas.

A method and apparatus that overcomes or ameliorates at least some of the above mentioned problems is desired.

According to a first aspect, there is provided a method of making a SERS active substrate. The method comprises depositing a first layer and replicating a plurality of pores of a nanoporous template layer in the first layer so as to define corresponding pores in the first layer. The first layer consists of a metal, and depositing the first layer comprises at least partially coating the sidewalls of the pores of the nanoporous template layer, thereby defining a plurality of out-of-plane SERS active nanofeatures in the first layer.

Each replicated pore of the template shares the same position as the corresponding pore in the first layer. Each pore in the first layer may at least partially replicate the size and shape of the corresponding pore in the template layer.

The term “SERS active” as used herein may relate to a substrate, layer or surface that is capable of supporting a SERS enhancement factor of at least 10¹², 10¹⁰, 10⁸, 10⁶, 10⁴, 10³, 10², or 10, with reference to a quartz substrate.

A reference to a layer being deposited on another layer does not require the layer to be directly in contact therewith, but encompasses the case where at least one intermediate layer is interposed therebetween. The pores in the template layer may be holes through the thickness of the template layer, and replicating the pores may mean forming corresponding holes (i.e. in the same position) through the thickness of another layer.

The nanoporous template layer may comprise a porous nanocrystalline silicon layer, or a nanoporous silicon nitride layer.

The first layer may be deposited on the nanoporous template layer by physical vapour or chemical vapour deposition.

The method may further comprise removing the nanoporous template layer to leave the first layer freestanding and self-supporting.

At least some of the nanofeatures may comprise openings through the first layer.

The openings may have a mean effective diameter of 5 nm to 200 nm.

The thickness of the first layer may be is between 5 nm and 100 nm.

The first layer may comprise: gold, silver, copper, aluminum, platinum, rhodium or iridium.

The method may further comprise forming a cavity in the substrate (e.g. by reactive ion etching or wet etching), the cavity defining a freestanding and self-supporting membrane comprising the first layer.

The first layer may be deposited on a second layer, the second layer disposed on the nanoporous template layer, wherein depositing the second layer comprises at least partially coating the sidewalls of the pores of the nanoporous template layer, thereby defining a plurality of out-of-plane nanofeatures in the second layer.

The method may comprise removing (e.g. by reactive ion or wet chemical etching) the nanoporous template layer before or after deposition of the first layer on to an second layer.

The second layer may comprise a Raman silent material.

The second layer may comprise a material that is substantially transparent over at least part of the wavelength range 500 nm to 1.4 microns.

The second layer may comprise a material selected from: magnesium fluoride, calcium fluoride, quartz, zinc sulphide, and zinc selenide.

The thickness of the second layer may be between 5 nm and 100 nm

The second layer may be deposited by physical vapour or chemical vapour deposition of the second layer onto the nanoporous template layer.

The method may further comprise forming a cavity in the substrate by reactive ion or wet chemical etching, the cavity defining a freestanding and self-supporting membrane comprising the first and second layers.

According to a second aspect, there is provided a SERS active substrate, having a freestanding and self-supporting membrane comprising a metal layer that includes a plurality of SERS active nanofeatures, wherein a plurality of the SERS active nanofeatures each comprise a through hole in the metal layer and a protrusion at the edge of the through hole.

The protrusion may surround the perimeter of the through hole.

The substrate may be prepared using the method of the first aspect.

The metal layer may comprise a metal selected from: gold, silver, copper, platinum, aluminum, rhodium or iridium.

Each protrusion may comprise a sidewall surface facing away from the through hole, and the sidewall surface may be at an obtuse angle to a plane of the metal layer, the angle measured exterior to the hole.

The thickness of the membrane may be between 5 nm and 200 nm.

The mean effective diameter of the through holes may be between 5 nm and 200 nm.

The freestanding and self-supporting membrane may further comprise a Raman silent support layer on which the metal layer is disposed, wherein the protrusions extend from the metal layer in the direction of the support layer.

The support layer may be substantially transparent over at least part of the wavelength range 500 nm to 1.4 microns.

According to a third aspect, there is provided a method of removing an adsorbed analyte from a SERS active substrate, comprising; bathing the substrate in an electrolyte, and applying an electrical potential difference between the electrolyte and a SERS active metal layer of the substrate.

The SERS active substrate may be according to the first or second aspect, and applying an electrical potential may comprise applying a voltage to the metal layer.

Applying a potential difference may comprise applying cyclic voltammetry to establish reductive or oxidative potentials whereby adsorbed analytes may be electrochemically modulated.

Applying a potential difference may comprise applying chronoamperometry to selectively desorb analytes from the metal layer.

Applying an electrical potential comprises applying a voltage to the metal layer relative to a reference electrode in contact with the same electrolyte.

The method may further comprise: performing a Raman analysis in which the analyte is adsorbed onto the SERS active surface; performing another Raman analysis using the SERS active substrate after the analyte has been removed.

According to a fourth aspect, there is provided a method of performing Raman spectroscopy using a SERS active substrate, comprising illuminating a SERS active surface of the substrate with monochromatic light through a support layer that is substantially transparent to the monochromatic light and which is in contact with the SERS active layer, and detecting inelastically scattered light through the support layer.

According to a fourth aspect, there is provided a device comprising a suspended membrane, the suspended membrane consisting of a freestanding and self-supporting material layer that includes a plurality of nanofeatures, wherein a plurality of the nanofeatures each comprise a through hole in the material layer and a protrusion at the edge of the through hole.

The membrane may be formed in accordance with the first aspect.

The membrane may have a thickness of between 5 nm and 200 nm, and may comprise a plurality of pores with effective diameter of between 5 nm and 200 nm.

According to a fifth aspect, there is provided a method of performing Raman spectroscopy using a substrate comprising a SERS active layer, the SERS active layer comprising a plurality of pores permitting flow of a fluid through the SERS active substrate.

According to a sixth aspect, there is provided a method of performing Raman spectroscopy using a SERS active substrate, comprising illuminating a SERS active surface of the substrate with monochromatic light through a support layer that is substantially transparent to the monochromatic light and which is in contact with the SERS active layer, and detecting inelastically scattered light through the support layer.

According to a seventh aspect, there is provided a method of performing Raman spectroscopy using a substrate comprising a SERS active layer, the SERS active layer comprising a plurality of pores permitting flow of a fluid through the SERS active substrate.

The method may further comprise driving electro-osmotic bulk flow through the SERS active layer by applying a voltage across the SERS active layer via electrodes immersed in the fluid.

The method may further comprise encouraging charged analytes to flow through the SERS active layer or to be immobilised at a surface of the SERS active layer by applying an electric potential between at least one of: electrodes in contact with the fluid; and/or the SERS active layer and at least one electrode immersed in the fluid.

The nanoporous template can be from types of nanoporous membranes known in the art. In an embodiment, the nanoporous template can be porous nanocrystalline silicon, as described in U.S. Pat. No. 8,182,590, the disclosure of which is incorporated herein by reference. In another embodiment, the nanoporous template can be nanoporous silicon nitride, as described in U.S. Patent Application No. 61/866,660, the disclosure of which with is incorporated herein by reference.

Embodiments of the invention will now be described, purely by way of example, with reference to the accompanying drawings, in which:

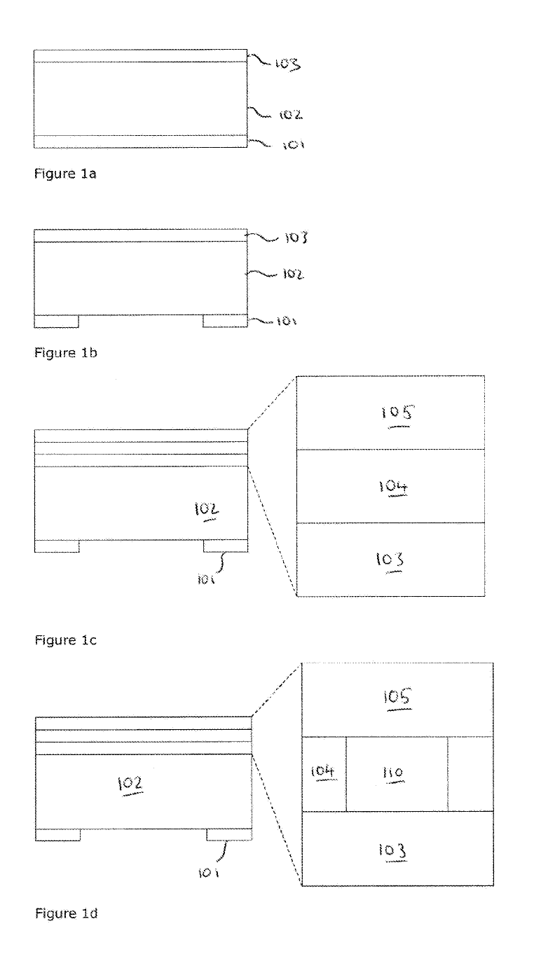

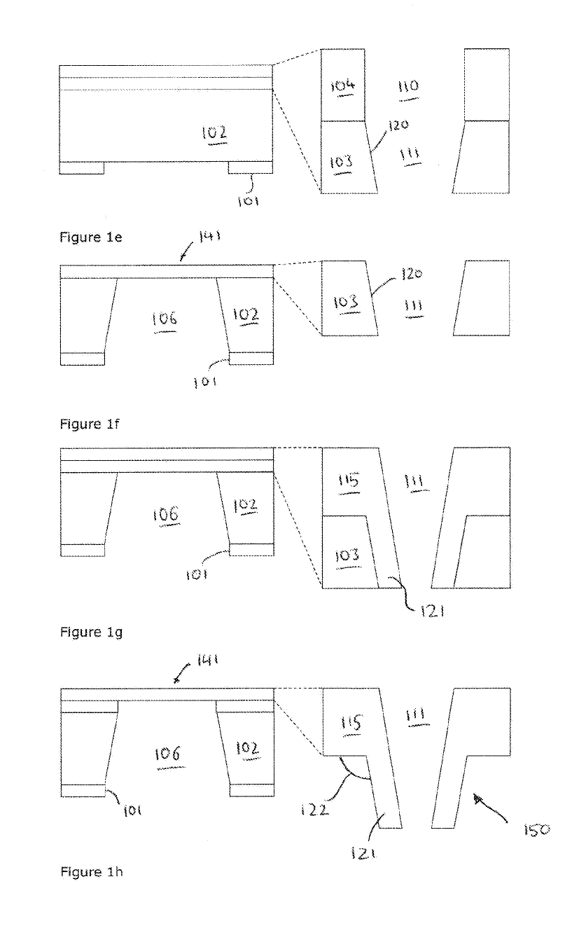

FIGS. 1a to 1h are sectional drawings, schematically illustrating a sequence of process steps for making a device in accordance with an embodiment;

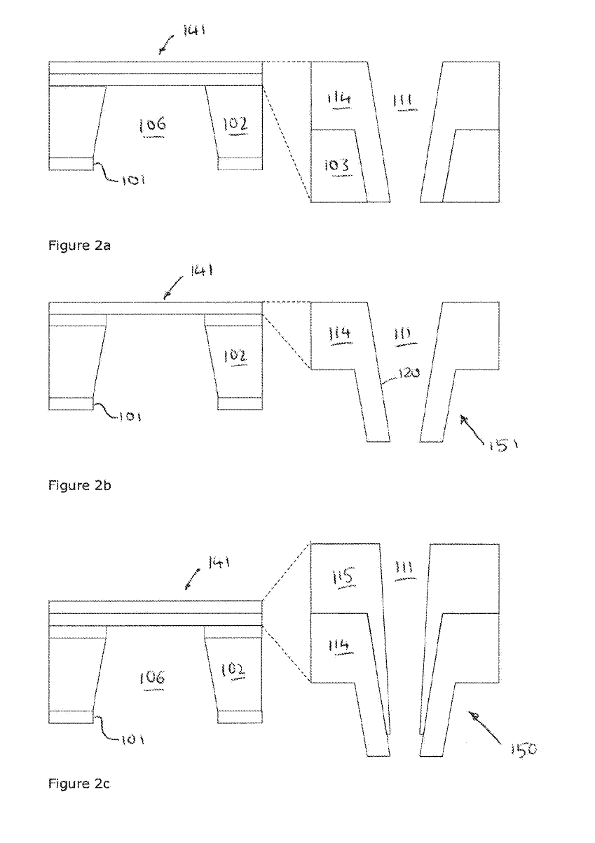

FIGS. 2a to 2c schematically illustrate a number of alternative steps for making a device in accordance with an embodiment;

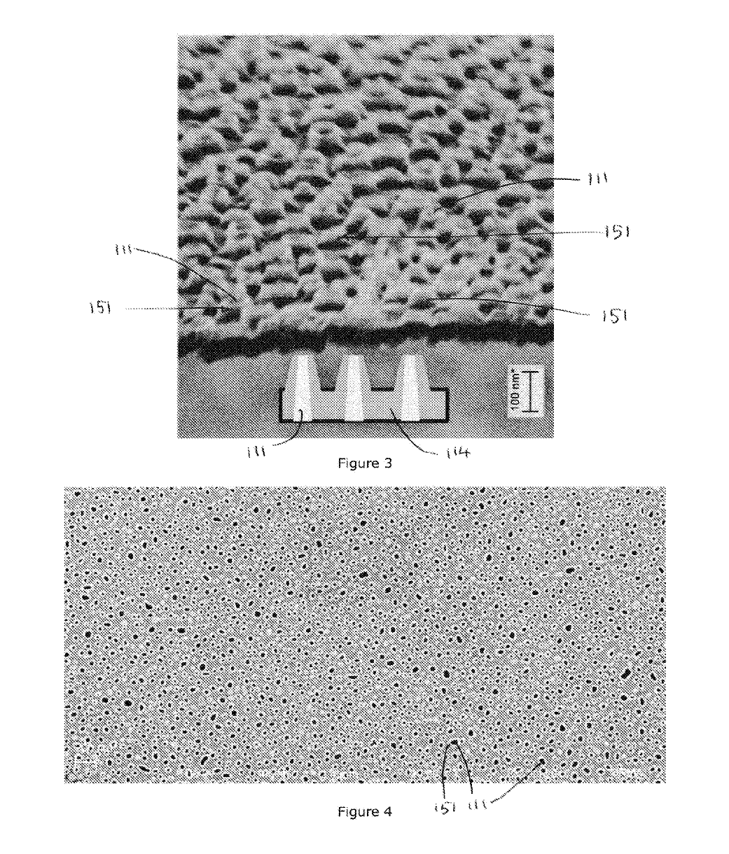

FIG. 3 is a scanning electron micrograph of an oblique view of an embodiment, showing nanofeatures and pores in a magnesium fluoride support layer prior to deposition of a metal layer;

FIG. 4 is a scanning electron micrograph of a plan view of an embodiment, showing the distribution of pores and nanofeatures over a region;

FIG. 5 is a scanning electron micrograph of a metal layer according to an embodiment;

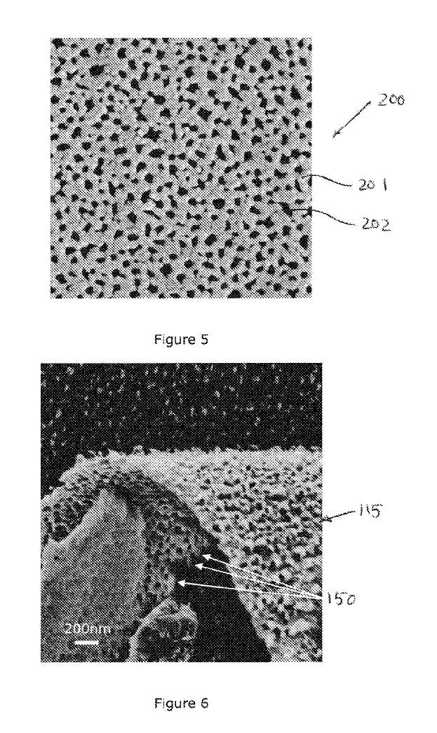

FIG. 6 is a scanning electron micrograph of a SERS active metal layer that has been peeled away from an underlying support layer, to show out-of-plane nanofeatures in the metal layer;

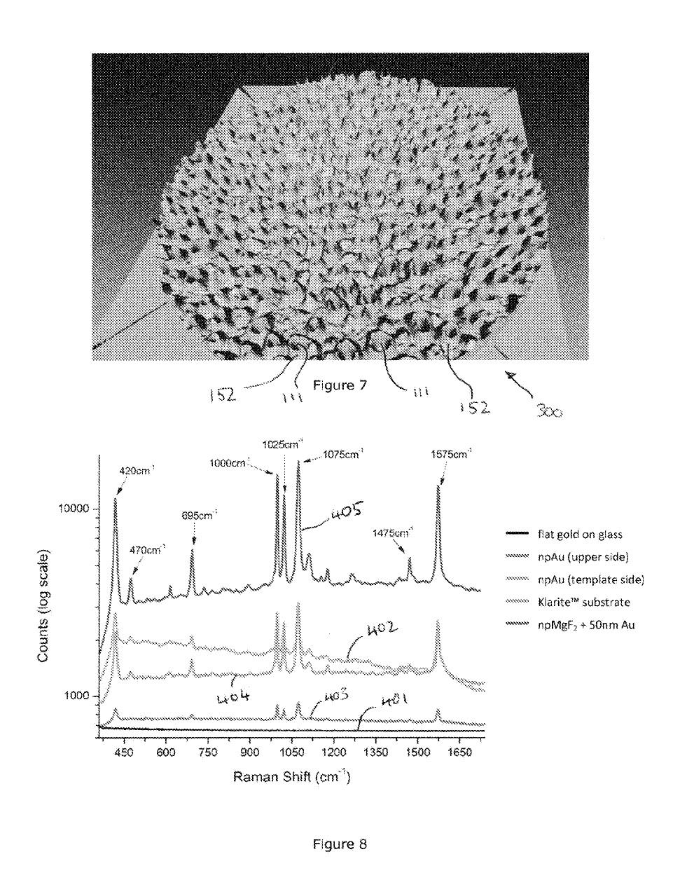

FIG. 7 is a view of a 3D model of an embodiment created by performing a multi-view object reconstruction method on a plurality of scanning electron micrographs of the embodiment;

FIG. 8 is a graph showing Raman spectra for a range of different measurement conditions, illustrating SERS from an embodiment by comparison with other substrates;

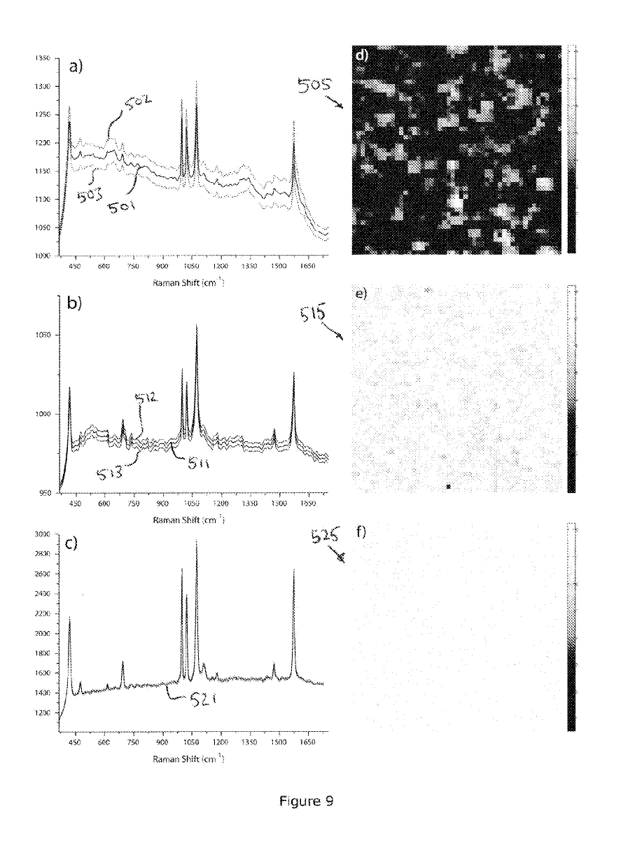

FIG. 9 is series of graphs and greyscale maps comparing uniformity of SERS enhancement over a region for embodiments, compared with a prior art SERS substrate;

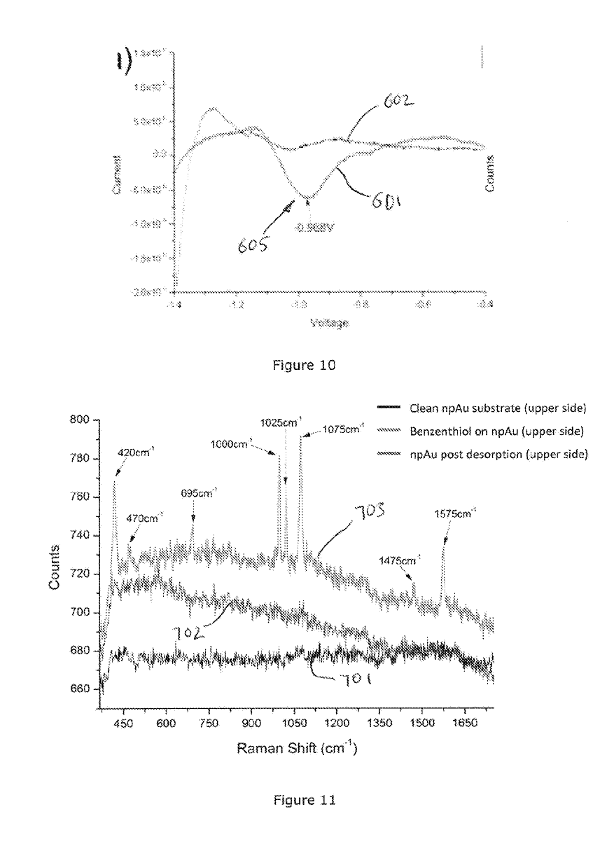

FIG. 10 is a voltammogram showing a cyclic electrochemistry in which an adsorbed analyte is removed by electrochemical desorption from a SERS active layer in accordance with an embodiment;

FIG. 11 is a graph showing Raman spectra for: a baseline SERS substrate according to an embodiment; a SERS substrate according to an embodiment to which an analyte has adsorbed; and the SERS substrate following electrochemical desorption and successful removal of the analyte;

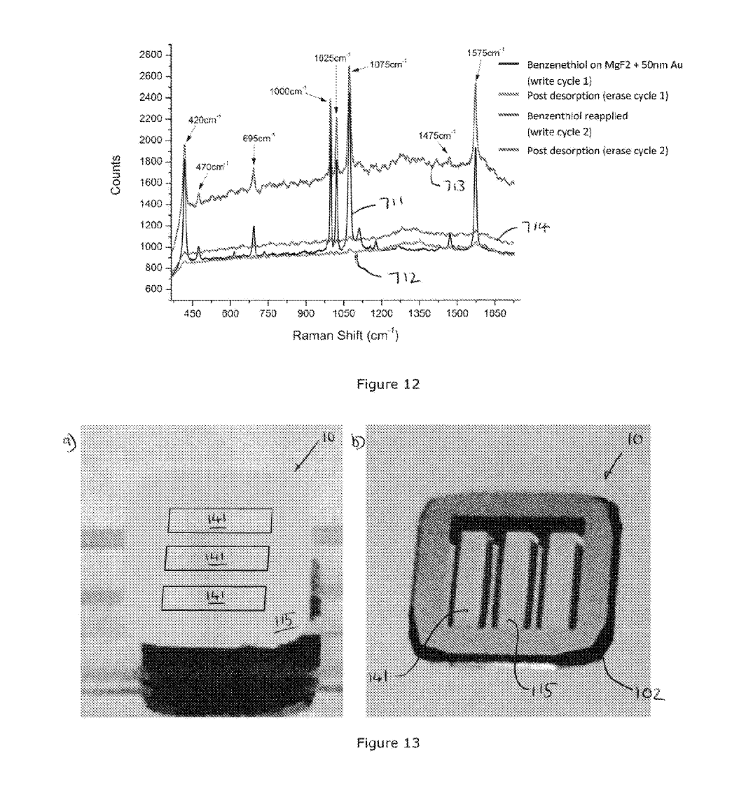

FIG. 12 a graph showing Raman spectra that illustrate “writing” and “erasing” analytes from the metal layer of an embodiment using electrochemistry;

FIG. 13 shows a front side view (a) and a backside view (b) of a SERS substrate comprising multiple SERS active nanoporous membranes, according to an embodiment; and

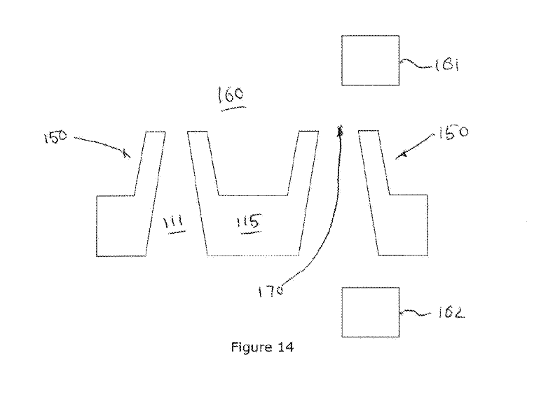

FIG. 14 schematically illustrates electro-osmotic flow through a porous membrane according to an embodiment.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar feature in modified and different embodiments.

The term “nanoporous” as used herein may relate to a material having a plurality of pores (e.g. through holes) with a mean effective diameter of less than 200 nm. The term “nanofeature” as used herein may relate to a feature (e.g. a protrusion or recess or hole/pore) having an extent of less than 200 nm. The term “effective diameter” as used herein in relation to a hole or pore may relate to a diameter of a circle with the same area as the hole or pore, as determined at an external surface of the layer comprising the pore. A mean effective hole diameter may refer to a mean determined on a number basis (e.g. not weighted by area).

In FIG. 1a a substrate layer 102 is shown, coated with a back-side silicon oxide (or silicon nitride) layer 101 and a front-side silicon nitride layer 103. The substrate layer 102 may be silicon, but other substrate materials may also be used (e.g. glass, sapphire, silicon carbide etc).

The back-side oxide 101 is patterned to define a hard mask for a subsequent etch (e.g. TMAH, KOH, DRIE Bosch process, etc) that defines a cavity 106 in the substrate 102. The back-side oxide 101 may, for example, be patterned by a lithographic process followed by an etch process (wet or dry). The substrate with patterned back-side oxide is shown in FIG. 1b. Silicon oxide is merely an example material, and other materials suitable for hard masking a through wafer etch may be used.

An amorphous silicon (a-Si) layer 104 is deposited on the front-side silicon nitride layer 103, and further silicon oxide layer 105 (or silicon nitride layer) deposited on the a-Si layer 104, so as to produce the device shown in FIG. 1c. The thickness of the a-Si layer 104 may be in the range 10 nm to 200 nm, for example, 50 nm. The thickness of the silicon nitride layer 103 may be similar to that of the a-Si layer 104, and may be in the range 10 nm to 200 nm, for example 50 nm or 40 nm.

The device may be subjected to a thermal process (e.g. a rapid thermal anneal), so as to crystallise the a-Si layer 104, thereby producing a nanoporous polycrystalline silicon layer 104, having a plurality of through-holes or pores 110, as shown in FIG. 1d (which illustrates a single pore). Pores produced in this way may be consistent, having a relatively narrow size distribution, and have a mean effective diameter of 5 nm to 200 nm. For instance, a 50 nm thick, nanoporous silicon layer 104 may be formed, having a plurality of pores with a mean effective diameter in the range 10 nm to 50 nm. This nanoporous silicon layer 104 may act as a template layer, with the pores of the nanoporous silicon layer 104 being replicated within the silicon nitride layer 10, so as to define corresponding pores (or through-holes) therein.

FIG. 1e illustrates the result of such a process. The silicon oxide layer 105 may be subsequently removed (for instance by an etch process, e.g. a dry reactive ion etch or a wet etch), and further etch process (e.g. a reactive ion etch) that is masked by the nanoporous silicon layer 104 used to transfer (or replicate) the pores 110 of the silicon layer 104 and produce corresponding pores 111 in the silicon nitride layer 103. Such an etch process may result in pores 111 having sidewalls 120 with a tapering profile, the pore 111 narrowing away from the template layer 104, as shown in FIG. 1e.

The nanoporous silicon template layer 104 may subsequently be removed (for instance by an etch process), to leave a layer nanoporous silicon nitride layer 103. A freestanding membrane 141 of nanoporous silicon nitride 104 may be created (as shown in FIG. 1f) by etching through the substrate layer 102, masked by the back-side oxide layer 101, to define a cavity 106.

A metal layer 115 may subsequently be deposited on the nanoporous nitride layer 103, as shown in FIGS. 1f and 1g. The metal layer 115 may, for instance, comprise a gold layer 115, but other metals capable of supporting a surface plasmon may also be used (e.g. platinum, copper, silver, aluminum etc). Notably, the present applicant has found that a metal layer 115 comprising a titanium adhesion layer and a subsequent gold layer is not suitable for supporting SERS.

In an example embodiment the metal layer 115 is a gold layer of around 50 nm, deposited directly onto the silicon nitride layer 103 (which may have a thickness of around 40 nm). The metal layer 115 may subsequently be annealed, for instance to improve the quality of the metal layer 115 (e.g. continuity, smoothness etc). For a metal layer 115 consisting of a 50 m gold layer, an anneal process at 600° C. for around 2 hours may be appropriate. Other materials may require a different heat treatment.

The metal layer 115 may be deposited by a physical vapour deposition process, such as sputtering or evaporation. The deposition process is preferably sufficiently conformal to coat at least part of the sidewalls 120 of the pores 111 defined in the nanoporous silicon nitride layer 103, so as to define a wall 121 that protrudes from the surface of the metal layer 115 (i.e. out-of-plane) in the direction of the silicon nitride layer 103, as shown in FIG. 1g. The ability of a directional deposition process to coat the sidewalls 120 of the pores 111 in a substantially circumferentially uniform manner may be improved by rotation of the substrate 102 during deposition of the metal layer 115. A circumferentially uniform coating of the sidewalls 120 results in a “nanovolcano” out-of-plane feature, having a frusto-conical exterior surface (and/or interior surface) and a substantially central through hole 111. These types of features have been found by the applicant to produce a greatly enhanced SERS effect compared with prior art nanostructured SERS active layers. In some embodiments, nanovolcanoes may not be formed. Instead a more directional deposition process may coat only part of the sidewall 120. Such features are still SERS active, although may provide a lower enhancement factor than nanovolcano type features.

The deposition of a metal layer 115 on a freestanding nanoporous membrane 141 means that the pores 111 may not be filled by the metal layer 115, but are instead left open. The pores 111 may be constricted by the walls 121 of the metal layer 115, but may not be completely filled.

The silicon nitride layer 103 may subsequently be removed, as shown in FIG. 1h, so as to produce a freestanding membrane 141 that is SERS active, consisting of the nanostructured metal layer 115. Removing the silicon nitride layer 103 may comprise performing a reactive ion etch from the back-side (i.e. through the cavity 106). For example, a gas mixture of CHF₃/O₂ at a ratio of 93:7 may be used, with a 5×10⁻⁵ Torr (6.7 mPa) base pressure and a 90 mTorr (12 Pa) operating pressure. A RF power of 75W may be applied.

The largest SERS enhancement factors may be produced by illuminating the layer 115 from the backside (i.e. through the cavity 106), because this enables the illuminating light and/or the Raman scattered light to interact with the nanofeatures 150 of the layer 115. The obtuse angle 122 defined by the exterior surface of the nanofeatures 150 with respect to a centroid of the metal layer 115 may enhance interaction of the light with the layer 115. The tapering frusto-conical exterior surface of the nanofeatures 150 may be a result of the sidewall angle produced by the replication of the pores 110 of the template layer. This process may be adjusted to produce an appropriate sidewall angle.

The process described above is scaleable and uses standard semiconductor processing techniques, making it suitable for volume manufacture of low cost SERS substrates. A SERS active layer 115 that is nanoporous, such that the pores 111 allow fluid to flow through the membrane 141, has a number of advantages over non-porous SERS substrates, for example in facilitating improved interaction of analytes by flowing through the nanopores, and enabling electro-osmotic flow control and selective control over mobility of analytes moving through the nanopores. Furthermore, the SERS active metal layer 115 may be electrically contiguous, enabling electrical potentials to be applied between the metal layer 115 and an electrolyte in which the metal layer 115 is in contact (e.g. via a reference electrode that is also contact with the electrolyte). This enables electrochemistry to be performed at the metal layer 115, potentially during SERS detection.

An example of a freestanding metal membrane 200 according to an embodiment is shown in FIG. 5. A 1.5 micron square field of view is shown, from the front-side (i.e. the direction from which the metal is deposited. Pores 202 in the nanostructured metal material 201 are visible, but the nanofeatures 150 produced by replication of the pores of the template/nitride layer are not visible, because these nanofeatures 150 are on the other side of the layer, internal to the “nanovolcanoes”.

FIG. 6 shows a similar membrane 200, peeled from the underlying layer (e.g. silicon nitride), so as to show the out-of-plane nanofeatures 150.

An alternative process for producing a SERS active substrate is shown in FIGS. 2a to 2c. This method may start from a freestanding nanoporous template layer 103, which may be formed in silicon nitride in a similar way to the embodiment of FIG. 1f. Alternatively a nanoporous silicon membrane may be used (e.g. dispensing with deposition of, and pore replication in, a nitride layer). In this method, a first layer 114 comprising a substantially transparent (e.g. at least 70% transmissive within at least part of the wavelength range 400 nm to 1.4 microns) Raman silent material may be deposited on the nanoporous membrane, so as to produce out-of-plane nanofeatures and pores in the first layer 114 (similar to those described above with reference to the metal layer 115 in FIGS. 1a to 1h). The first layer 114 may comprise a material selected from: magnesium fluoride, calcium fluoride, quartz, zinc sulphide and zinc selenide. Raman scattering may be performed by illuminating through such a first layer without a significant contribution to the Raman spectra from the material of the support layer.

The first layer 114 may be deposited by evaporation, and may be annealed after deposition to improve the film quality. The first layer 114 may have a thickness between 5 nm and 200 nm, for example 50 nm. In the case of a 50 nm layer of magnesium fluoride, a 700° C. anneal for two hours performed on an evaporated layer may produce appropriate layer quality.

The template layer 103 may subsequently be removed, for example by etching (e.g. wet etch, reactive ion etch) to leave a freestanding membrane 141 of the first material layer 114 (e.g. magnesium fluoride), as shown in FIG. 2b. FIG. 3 shows a micrograph of a region of such a membrane, in which the out-of-plane nanofeatures 151 (“nanovolcanoes”) are clearly visible. FIG. 4 shows a micrograph of a similar material in plan view, illustrating the substantially uniform dense distribution of pores 111 with a relatively narrow size range. The nanofeatures 151 are approximately 20 nm to 50 nm in height, and the pores 111 may have a mean effective diameter in the range 10 nm to 100 nm. FIG. 7 shows a further view of such a layer, with nanofeatures 152 and pores 111 clearly visible.

A metal layer 115 may subsequently be deposited on the nanoporous first layer 114 (in a similar way as described above with reference to FIGS. 1a to 1h), so as to replicate the out-of-plane nanofeatures of the first layer 114 in the metal layer 115, by coating the interior sidewall surfaces 120 of the nanofeatures 151 of the first layer 114 with the metal layer 115. The first layer 114 partially infilling the pores of the nanoporous template layer 103 results in a slight reduction in the size of the pores.

The use of a first layer 114 in combination with the metal layer 115 may considerably enhance the robustness of the metal layer 114, and the combined first layer 115, metal layer 115 membrane may exhibit improved SERS enhancement factors (measured from the backside, through the cavity 106), relative to a freestanding metal layer 115 without a supporting first layer 114.

FIG. 8 shows Raman spectra for benzenethiol (thiophenol) obtained from: a flat gold layer on a glass substrate 401; a Klarite® substrate 402; a freestanding nanoporous metal membrane in accordance with an embodiment (similar to FIG. 1h), measured from the front-side 403; a freestanding nanoporous metal membrane substrate in accordance with an embodiment (similar to FIG. 1h), measured from the back-side (i.e. template-side) 404; and 405 from an embodiment similar to FIG. 2c, with the metal layer on a transparent, Raman silent layer (in the case, 50 nm Au on 50 nm MgF₂). Integration times for all spectra except 401 are 10s, with 2 mW laser power.

The spectra 401 was taken with 150 mW laser power and 20s integration time. The arrows on the traces indicate typical benzenethiol Raman vibrational frequencies.

Some SERS enhancement is observed for the substrate according to an embodiment even from the front-side 403, but when a measurement 403 is taken on the more active side of the SERS metal layer 114 (i.e. the side with the out-of-plane nanofeatures 150), a SERS enhancement of similar magnitude to a Klarite® substrate is observed.

Although free-standing nanoporous metal membranes (without a support layer) achieve high levels of SERS enhancement (comparable with commercially available SERS substrates), greatly improved SERS enhancement is achievable in some embodiments. The Raman spectrum 405 shows improvement of around at least an order of magnitude in SERS enhancement, over a Klarite® substrate.

Furthermore, the high density (e.g. >200 SERS active nanofeatures per 1×1 micron region), small size and substantially uniform but irregular nature of the out-of-plane nanofeatures in accordance with an embodiment may result in improved uniformity of SERS enhancement over the surface of the substrate. This is illustrated in FIG. 9a-f, which compare SERS enhancement over a region of a Klarite® substrate with that obtained from embodiments.

FIG. 9a shows an average Raman spectrum 501 obtained from a 50 by 50 micro measurement area for a Klarite® substrate, and the dotted lines 502, 503 show one standard deviation from the average 501. FIG. 9b shows a similar average Raman spectrum 511 for a substrate according to an embodiment comprising a freestanding porous metal membrane and standard deviations 512 and 513. FIG. 9c shows an average Raman spectrum 521 for a substrate according to an embodiment similar to FIG. 2c, with the metal layer on a transparent, Raman silent layer (in the case, 50 nm Au on 50 nm MgF₂). The standard deviation from the average spectrum 521 are too close to the average values to be readily distinguished.

FIGS. 9d, 9e and 9f respectively show the 50×50 micron maps obtained by plotting the intensity at 1075 cm⁻¹ for the same measurement conditions as are respectively described for FIGS. 9a, 9b and 9c. Again, it can be seen that uniformity of SERS enhancement is improved according to embodiments over the prior art.

In some embodiments, the metal layer 115 may by electrically contiguous, thereby enabling electrochemistry to be performed on an analyte in contact with the metal layer 115. This provides major potential for utility and applicability as a biosensor, for instance for an array of analytes. An array of cavities 106 and corresponding SERS active membranes 141 may be formed on a substrate, and used to perform analysis on an array of analytes.

By applying an electrical potential difference between the metal layer 115 and an electrolyte in contact with the metal layer 115 (e.g. bathing it), it is possible to perform electrochemistry using the metal layer 115. For instance, cyclic voltammetry may be used to establish reductive or oxidative potentials whereby adsorbed analytes may be electrochemically modulated. Chronoamperometry may be used to selectively desorb analytes from the metal layer 115.

Referring to FIG. 10, a voltammogram is shown, illustrating the characteristic negative current flow peak 605 at −0.968V in curve 601, which corresponds with Au-thiol bond breakage. In curve 602, the voltage is increased from −1.4V to −0.4V, and in curve 601, the voltage is decreased from −0.4V to −1.4V. Curves 602 and 601 are difference curves obtained between post- and pre-desorptiob of the benzenethiol layer, with 601 indicating the negative going and 602 indicating the positive going phase of a cyclic voltammetry process.

FIG. 11 shows Raman spectra that illustrate a successful electrochemical read/write operation, adsorbing and desorbing a benzenethiol analyte to a metal layer 115 in accordance with an embodiment comprising a free standing metal layer (e.g. Au). Spectrum 703 is obtained after the analyte is adsorbed on the metal layer 115, spectrum 702 is obtained after a potential of −0.9V was applied to the metal layer 115, relative to the electrolyte, for 5 minutes. Spectrum 703 does not include the characteristic benzenethiol Raman peaks, so indicates that the analyte has successfully been removed. A reference baseline spectrum 701 is also shown (on a clean substrate). This approach can be used, for instance, to clean a substrate, so that the substrate can be re-used for SERS after the previous analyte has been “erased” by electrochemical desorption. The excitation wavelength was 725 nm, with 2 mW power and 10s integration time.

FIG. 12 shows Raman spectra that illustrate a successful electrochemical read/write operation, adsorbing and desorbing a benzenethiol analyte to a metal layer 115 in accordance with an embodiment that comprises a metal layer on a transparent Raman silent layer. Spectrum 711 is obtained after the analyte is adsorbed on the metal layer 115, spectrum 712 is obtained after a potential was applied to the metal layer 115, relative to the electrolyte, to erase the adsorbed analyte. Spectrum 711 does not include the characteristic benzenethiol Raman peaks, so indicates that the analyte has successfully been removed. Spectrum 713 was taken after a second “write” operation, in which the analyte is adsorbed on the metal layer, and spectrum 714 was taken after a second “erase” operation, to electrochemically remove the analyte. Arrows represent typical benzenthiol Raman vibrational frequencies. Experiments were performed using 725 nm excitation wavelength, 2 mW power and 1s integration time for all the spectra but blue, where a 5s integration time was used. Each erase cycle comprises applying approximately −0.9V for 300s.

The through-pores 111 of a SERS active membrane in accordance with an embodiment enable a filtering operation to be performed using an embodiment. In some embodiments an electro-osmotic fluid flow may be encouraged through the SERS active membrane 141 by applying a transmembrane voltage, for instance via at least one electrode in contact with the fluid and/or by applying a voltage to the metal layer 115, as illustrated in FIG. 14. Charged analytes in an electrolyte 160 may be encouraged to flow through the pores 111, for instance in the direction indicated by arrow 170 (or the opposite direction), in response to electrical potential differences applied across the membrane, via electrodes 161, 162 in contact with the electrolyte 160 and/or the metal layer 115.

FIG. 13 shows an SERS substrate 10 in accordance with an embodiment. The substrate 10 comprises a silicon die comprising a substrate layer 102, which is patterned with three cavities, defining three nanoporous SERS active membranes 141 suspended over the cavities. In this example, the membranes 141 consist of freestanding nanoporous metal layers 141, as described above with reference to FIG. 1h.

From reading the present disclosure, other variations and modifications will be apparent to the skilled person. Such variations and modifications may involve equivalent and other features which are already known in the art of micro-fabrication and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality.

1. A method of making a SERS active substrate, comprising:
depositing a first layer and replicating a plurality of pores of a nanoporous template layer in the first layer so as to define corresponding pores in the first layer; and
the first layer consisting of a metal and, wherein depositing the first layer comprises at least partially coating the sidewalls of the pores of the nanoporous template layer, thereby defining a plurality of out-of-plane SERS active nanofeatures in the first layer.

2. The method of claim 1, wherein the nanoporous template layer comprises a porous nanocrystalline silicon layer, or a nanoporous silicon nitride layer.

3-4. (canceled)

5. The method of claim 1, wherein at least some of the nanofeatures comprise openings through the first layer, wherein the openings have a mean effective diameter of 5 nm to 200 nm.

6. (canceled)

7. The method of claim 1, wherein the thickness of the first layer is between 5 nm and 100 nm.

8. The method of claim 1, wherein the first layer comprises: gold, silver, copper, platinum, aluminium, rhodium or iridium.

9. The method of claim 1, further comprising forming a cavity in the substrate, the cavity defining a freestanding and self-supporting membrane comprising the first layer.

10. The method of claim 1, wherein the first layer is deposited on a second layer, the second layer disposed on the nanoporous template layer, wherein depositing the second layer comprises at least partially coating the sidewalls of the pores of the nanoporous template layer, thereby defining a plurality of out-of-plane nanofeatures in the second layer.

11. The method of claim 10, comprising removing the nanoporous template layer before or after deposition of the first layer on to an second layer.

12. The method of claim 10, wherein the second layer comprises a Raman silent material.

13. The method of claim 10, wherein the second layer comprises a material that is substantially transparent over at least part of the wavelength range 500 nm to 1.4 microns.

14. The method of claim 10, wherein the second layer comprises a material selected from: magnesium fluoride, calcium fluoride, quartz, zinc sulphide, and zinc selenide.

15. The method of claim 10, wherein the thickness of the second layer is between 5 nm and 100 nm

16. (canceled)

17. The method of claim 10, further comprising forming a cavity in the substrate by reactive ion or wet chemical etching, the cavity defining a freestanding and self-supporting membrane comprising the first and second layers.

18. A SERS active substrate, having a freestanding and self-supporting membrane comprising a metal layer that includes a plurality of SERS active nanofeatures, wherein a plurality of the SERS active nanofeatures each comprise a through hole in the metal layer and a protrusion at the edge of the through hole.

19. The SERS active substrate of claim 18, wherein the protrusion surrounds the perimeter of the through hole.

20. The SERS active substrate of claim 18, wherein the SERS active substrate is prepared using the method comprising:
depositing the metal layer and replicating a plurality of pores of a nanoporous template layer in the metal layer so as to define corresponding through holes in the metal layer; and
wherein depositing the metal layer comprises at least partially coating the sidewalls of the pores of the nanoporous template layer, thereby defining the plurality of the SERS active nanofeatures in the metal layer.

21. (canceled)

22. The SERS active substrate of claim 18, wherein each protrusion comprises a sidewall surface facing away from the through hole, and the sidewall surface is at an obtuse angle to a plane of the metal layer, the angle measured exterior to the hole.

23. The SERS active substrate of claim 18, wherein the thickness of the membrane is between 5 nm and 200 nm and/or wherein the mean effective diameter of the through holes is between 5 nm and 200 nm.

24. (canceled)

25. The SERS active substrate of claim 18, wherein the freestanding and self-supporting membrane further comprises a Raman silent support layer on which the metal layer is disposed, wherein the protrusions extend from the metal layer in the direction of the support layer.

26. The SERS active substrate of claim 25, wherein the support layer is substantially transparent over at least part of the wavelength range 500 nm to 1.4 microns.

27.-41. (canceled)
